(19) United States
(12) Patent Application Publication
(10) Pub. No.: US 2026/0216888 A1
(43) Pub. Date: Jul. 30, 2026

(54) METHOD FOR MANUFACTURING MEASUREMENT DEVICE, AND ROBOT ARM

(71) Applicant: DIC Corporation, Tokyo (JP)

(72) Inventors: Kunito Kurata, Tokyo (JP); Kotaro Mori, Tokyo (JP)

(73) Assignee: DIC Corporation, Tokyo (JP)

(21) Appl. No.: 19/578,251

(22) Filed: Mar. 25, 2026

Related U.S. Application Data
(63) Continuation of application No. PCT/JP2024/036903, filed on Oct. 16, 2024.

(30) Foreign Application Priority Data
Nov. 6, 2023 (JP) 2023-189468

(51) Int. Cl. B25J 13/08; G01L 5/00

(52) U.S. Cl. CPC B25J 13/082; G01L 5/0061

(57) ABSTRACT

A method for manufacturing a measurement device integrally including a sensor that measures a force, includes: forming, with a first resin, a main body portion of the measurement device; and forming, on a surface of the first resin, a circuit as a plating layer to be integrated with the first resin. The circuit outputs an electrical signal that changes depending on an amount of strain on the main body portion.

### CROSS-REFERENCE TO RELATED APPLICATIONS

The present application claims priority from Japanese Patent Application No. 2023-189468, filed on Nov. 6, 2023, the entire contents of which are incorporated herein by reference.

### BACKGROUND

### Technical Field

The present disclosure relates to a method for manufacturing a measurement device and a robot arm.

### Description of Related Art

In the related art, there are known robot arms for various uses such as an industrial use in a manufacturing site or the like, a medical use, and a nursing care use. In addition, there is known a technique related to an end effector including a robot hand, a robot gripper, and the like, which is attached to a distal end of a robot arm. For example, Patent Document 1 discloses a method for manufacturing a force sensor that can be used by being attached to an end effector or the like and can increase sensitivity as compared with a force sensor in the related art.

### PATENT DOCUMENT

Patent Document 1: JP 2023-19682 A

An end effector that can be used as a measurement device contributing to measurement of a force is required to have a reduced number of components, a reduced size, and a reduced weight due to the weight capacity limit of a robot arm. In addition, for the purpose of prevention of spread of infection and other hygienic aspects, the end effector is required to be waterproof and water-resistant so that the end effector can be cleaned. In general, an end effector is made of a metal and is heavy, and the end effector rusts during cleaning.

An end effector typically requires a sensor component to perform the operation. For example, a sensor component such as a force sensor as in the related art described in Patent Document 1 is additionally mounted on the end effector in order for the robot arm to determine whether or not the end effector has gripped a target object. This makes it difficult to reduce the size and the weight of the end effector.

### SUMMARY

The present disclosure is directed to providing a method for manufacturing a measurement device that can measure a force with a simpler configuration, and a robot arm.

A method for manufacturing a measurement device according to a first aspect is a method for manufacturing a measurement device integrally having a sensor that measures a force, the method including:
forming, with a first resin, a main body portion of the measurement device; and
forming, on a surface of the first resin, a circuit as a plating layer to be integrated with the first resin. The circuit outputs an electrical signal that changes depending on an amount of strain on the main body portion.

A robot arm according to a second aspect includes, as an end effector, the measurement device manufactured by the above-described method.

According to the present disclosure, it is possible to provide a method for manufacturing a measurement device that can contribute to measurement of a force with a simpler configuration, and a robot arm.

### BRIEF DESCRIPTION OF DRAWINGS

FIG. 1 is an external perspective view illustrating an example of a robot arm according to one or more embodiments of the present disclosure.

FIG. 2 is a block diagram illustrating an example of the configuration of the robot arm in FIG. 1.

FIG. 3 is a first external perspective view illustrating an example of an end effector of the robot arm in FIG. 1.

FIG. 4 is a second external perspective view illustrating an example of the end effector of the robot arm in FIG. 1.

FIG. 5 is a side view illustrating a part of the configuration of the end effector in FIG. 3.

FIG. 6 is an enlarged cross-sectional view schematically illustrating a part of a cross section taken along an arrow line VI-VI in FIG. 5 in an enlarged manner.

FIG. 7 is a flowchart for explaining an example of a manufacturing method when the end effector in FIG. 1 is manufactured as a measurement device.

### DETAILED DESCRIPTION OF EMBODIMENTS

Hereinafter, embodiments of the present disclosure will be mainly described with reference to the accompanying drawings.

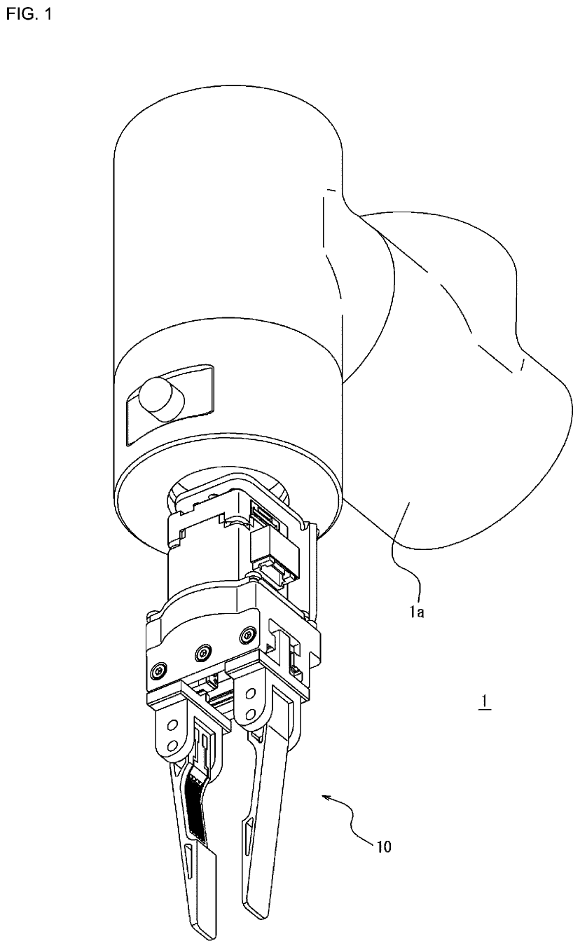

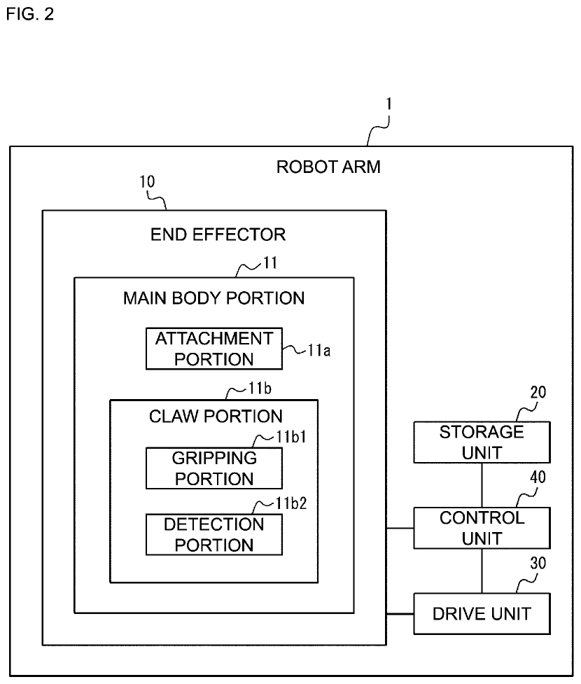

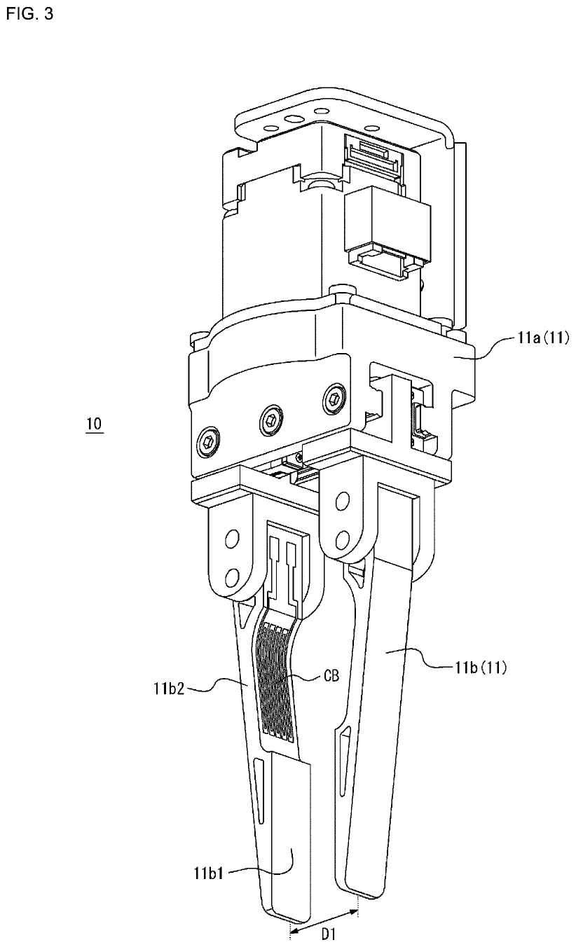

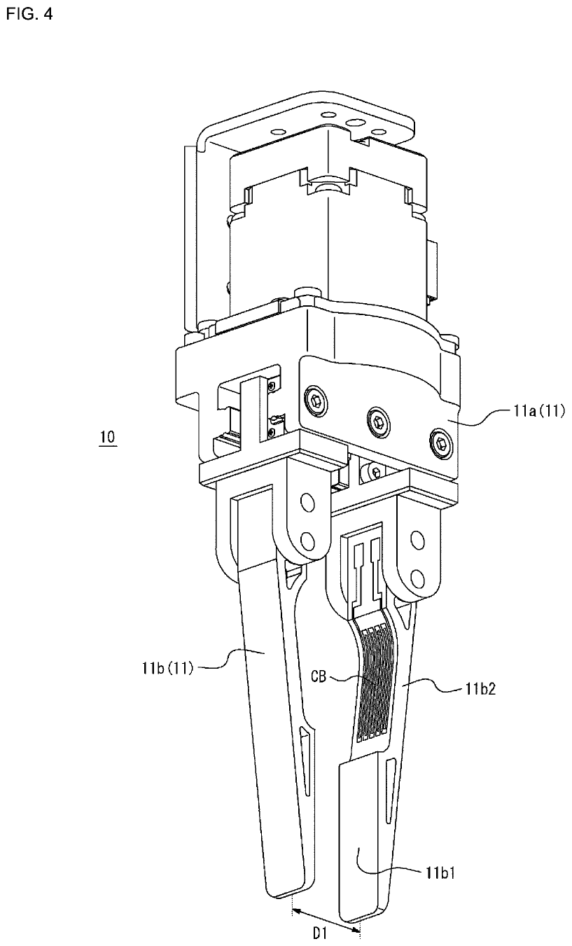

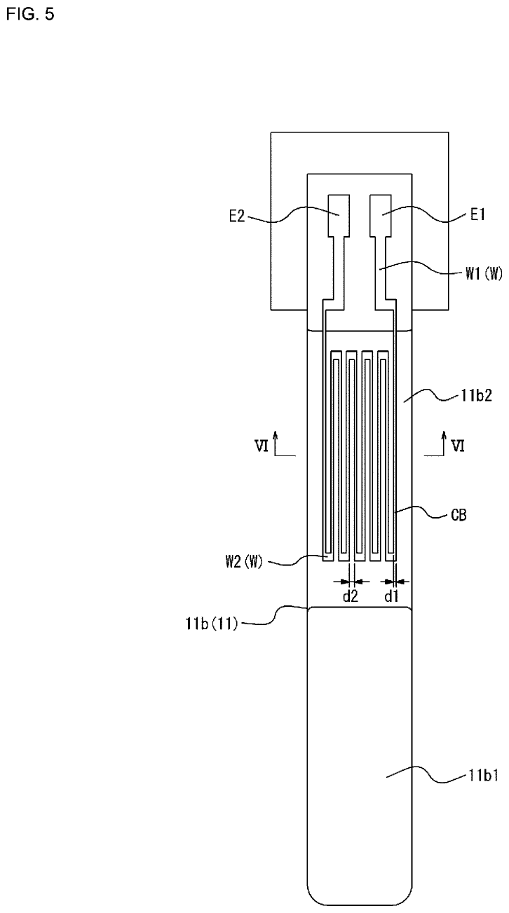

FIG. 1 is an external perspective view illustrating an example of a robot arm 1 according to one or more embodiments of the present disclosure. FIG. 2 is a block diagram illustrating an example of the configuration of the robot arm 1 in FIG. 1. FIG. 3 is a first external perspective view illustrating an example of an end effector 10 of the robot arm 1 in FIG. 1. FIG. 4 is a second external perspective view illustrating an example of the end effector 10 of the robot arm 1 in FIG. 1. FIG. 5 is a side view illustrating a part of the configuration of the end effector 10 in FIG. 3. An example of the configuration of the robot arm 1 including the end effector 10 according to one or more embodiments as a measurement device will be mainly described with reference to FIGS. 1 to 5.

As illustrated in FIGS. 1, 3, 4, and the like, the robot arm 1 includes a housing 1a constituting a main body, and the end effector 10 attached to the housing 1a at a distal end of the robot arm 1. The end effector 10 corresponds to the measurement device described in the claims. An end portion of the end effector 10 on the opposite side of a portion for gripping a target object is attached to the housing 1a, whereby the end effector 10 is supported by the housing 1a. The end effector 10 is driven in a state of being supported by the housing 1a, and grips a target object. The end effector 10 measures a force received due to a counteraction when the target object is gripped.

In the present disclosure, the “target object” includes a solid object or the like that can be gripped by the end effector 10. The target object is not limited thereto, and may include any other object to be gripped by the end effector 10.

The end effector 10 is used for a robot. For example, the end effector 10 functions as a part of a robot having the robot arm 1. In the present disclosure, the “robot” includes, for example, an industrial robot, a nursing care robot, a marine robot, a medical robot, and a moving body such as a vehicle or a drone that autonomously makes a determination and moves. The “industrial robot” includes, for example, a collaborative robot that can perform work together with a worker in the same space, another robot that performs work in a state of being isolated from the worker, and the like. The end effector 10 is configured as a robot hand or a robot gripper in such a robot.

As illustrated in FIGS. 2 to 4, the end effector 10 has a main body portion 11. The main body portion 11 constitutes the entire outer shape of the end effector 10. The main body portion 11 has an attachment portion 11a attached to the housing 1a of the robot arm 1. The main body portion 11 has a pair of claw portions 11b protruding from an end portion of the attachment portion 11a, the end portion being located on the side opposite to the housing 1a. The pair of claw portions 11b grips a target object by, for example, reducing the separation distance between the claw portions to be substantially equal to the width of the target object.

The claw portions 11b each include a gripping portion 11b1 and a detection portion 11b2. The gripping portion 11b1 is located at a distal end of the main body portion 11 on the side opposite to the attachment portion 11a. The gripping portions 11b1 grip the target object. The detection portion 11b2 is formed in the main body portion 11 in such a manner that one end portion of the detection portion 11b2 is attached to the attachment portion 11a and the other end portion is continuous with the gripping portion 11b1. The detection portion 11b2 is strained depending on a force applied to the gripping portion 11b1. The detection portion 11b2 is thinner than the gripping portion 11b1 in a separation direction D1 in which the pair of claw portions 11b is separated from each other, for example.

The end effector 10 is driven in a state of being supported by the housing 1a, and the separation distance of the pair of gripping portions 11b1 located at the distal end of the end effector 10 is reduced along the separation direction D1 to be substantially equal to the width of the target object, thereby gripping the target object by the pair of gripping portions 11b1. The end effector 10 measures a force received as a counteraction when the target object is gripped based on the strain on the detection portion 11b2 based on the gripping of the target object by the gripping portions 11b1.

The main body portion 11 contains a resin. As an example, the entire main body portion 11 including the attachment portion 11a and the claw portions 11b is formed of a resin. The detection portion 11b2, which contributes to the measurement of the force received by the counteraction when the target object is gripped, also contains a resin.

As described below, in the present disclosure, the resin contained in the main body portion 11 includes, for example, a thermoplastic resin. The “thermoplastic resin” includes, for example, at least one selected from the group consisting of a general-purpose plastic, an engineering plastic, and a super engineering plastic. The thermoplastic resin is, for example, a polyarylene sulfide resin. More specifically, the thermoplastic resin includes a polyarylene sulfide resin such as a polyphenylene sulfide resin.

As illustrated in FIG. 2, the robot arm 1 includes a storage unit (or storage) 20, a drive unit (or driver) 30, and a control unit (or controller) 40 in addition to the end effector 10 including the main body portion 11. The storage unit 20, the drive unit 30, and the control unit 40 are accommodated in the housing 1a of the robot arm 1.

The storage unit 20 includes, for example, a semiconductor memory, a magnetic memory, an optical memory, or any combination thereof. The storage unit 20 functions as, for example, a main storage device, an auxiliary storage device, or a cache memory. The storage unit 20 stores information used for the operation of the robot arm 1 and information obtained by the operation of the robot arm 1. For example, the storage unit 20 stores instructions including a system program, an application program, and various data acquired by any means such as communication.

The drive unit 30 includes, for example, any drive mechanism for driving the end effector 10. The drive mechanism includes, for example, a plurality of gears, a motor for rotating the gears, and the like. The drive unit 30 drives the end effector 10 in accordance with a control signal from the control unit 40. The drive unit 30 drives the claw portions 11b in accordance with a control signal from the control unit 40 in such a manner that the claw portions 11b of the main body portion 11 of the end effector 10 grip the target object, for example.

The control unit 40 includes a microcontroller, a processor, a programmable circuit, a dedicated circuit, or any combination thereof. The processor is a general-purpose processor such as a CPU or a GPU, or a dedicated processor specialized for specific processing. “CPU” is an abbreviation for Central Processing Unit. “GPU” is an abbreviation for Graphics Processing Unit. The programmable circuit is, for example, an FPGA. “FPGA” is an abbreviation for Field-Programmable Gate Array. The dedicated circuit is, for example, an ASIC. “ASIC” is an abbreviation for Application Specific Integrated Circuit. The control unit 40 is communicably connected to each component of the robot arm 1, and executes various types of processing related to the operation of the robot arm 1 while controlling each component.

As illustrated in FIG. 5, the detection portion 11b2 is formed integrally with the resin, and has a circuit CB that outputs an electrical signal that changes depending on an amount of the strain on the detection portion 11b2. The circuit CB is formed on each of the inner surfaces of the pair of claw portions 11b, for example, in the separation direction D1 in which the pair of claw portions 11b is separated from each other. The inner surfaces of the claw portions 11b are each a surface located on the same side as a front side of the claw portion 11b, the front side being the side on which the claw portion 11b grips the target object. The circuit CB is formed on the inner surface of the claw portion 11b over the entire detection portion 11b2 excluding the gripping portion 11b1. The circuit CB functions as a sensor that contributes to the measurement of a force. The measurement device has such a sensor integrated therein.

The circuit CB is formed by, for example, being directly drawn on the surface of the resin forming each of the detection portions 11b2 of the main body portion 11. In the circuit CB, wiring and an electrode are formed in respective regions of the surface of the resin forming the detection portion 11b2. The circuit CB is configured as a molded circuit using LDS of an MID, for example. “MID” is an abbreviation for Molded Interconnect Device. “LDS” is an abbreviation for Laser Direct Structuring. The circuit CB is formed by plating by directly irradiating the surface of the detection portion 11b2 as a molded article with laser.

The circuit CB has wiring W formed on the surface of the resin of the detection portion 11b2. The circuit CB has an input electrode E1 and an output electrode E2 formed on the surface of the resin of the detection portion 11b2. The input electrode E1 and the output electrode E2 are formed in parallel with each other. The wiring W of the circuit CB includes a plurality of straight lines connecting the input electrode E1 and the output electrode E2 which are formed integrally with the resin.

For example, the wiring W includes a connection line W1 that extends linearly from each of the input electrode E1 and the output electrode E2 and is bent at 90°. The wiring W includes a gauge line W2 connecting two end portions of the two connection lines W1, the two end portions being located on the opposite sides of the input electrode E1 and the output electrode E2, respectively. The gauge line W2 functions as a strain gauge. For example, the gauge line W2 is formed by repeatedly folding a straight line by 180° on one end side and further folding the folded straight line by 180° on the other end side.

A width d1 of the line of the wiring W, for example, the gauge line W2 is not particularly limited, but is preferably 1 mm or less, more preferably 500 μm or less, more preferably 250 μm or less, more preferably 200 μm or less, more preferably 150 μm or less, and still more preferably 100 μm or less. The lower limit value of the width d1 is not particularly limited, but is, for example, preferably 10 μm or more, more preferably 20 μm or more, more preferably 30 μm or more, more preferably 40 μm or more, and still more preferably 50 μm or more.

In the wiring W, an interval d2 of lines between a pair of gauge lines W2 adjacent to each other is not particularly limited, but is, for example, preferably 1 mm or less, more preferably 500 μm or less, more preferably 250 μm or less, more preferably 200 μm or less, more preferably 150 μm or less, and still more preferably 100 μm or less. The lower limit value of the interval d2 is not particularly limited, but is, for example, preferably 10 μm or more, more preferably 20 μm or more, more preferably 30 μm or more, more preferably 40 μm or more, and still more preferably 50 μm or more.

As an example, each of the width d1 and the interval d2 may be narrowed to about 50 μm.

The circuit CB formed on the front face of the detection portion 11b2 outputs an electrical signal that changes depending on an electrical resistance of the wiring W itself to the control unit 40. This causes the detection portion 11b2 to contribute to the measurement of the force by the control unit 40 based on the wiring W itself. For example, the circuit CB includes a strain gauge. More specifically, the circuit CB functions as a strain gauge based on the configuration of the wiring W described above.

For example, when each of the detection portions 11b2 is distorted with the gripping of the target object by the gripping portions 11b1, the wiring W formed as a plurality of straight lines connecting the input electrode E1 and the output electrode E2 is also strained, and the electrical resistance of the wiring W changes depending on the extent of strain. The amount of strain in the detection portion 11b2 and the electrical resistance value of the wiring W are correlated with each other. As described above, the voltage between the input electrode E1 and the output electrode E2 changes depending on an amount of the strain on the detection portion 11b2. The circuit CB outputs a voltage signal corresponding to the electrical resistance of the wiring W itself that changes depending on an amount of the strain on the detection portion 11b2 to the control unit 40 as an example of the electrical signal described above.

For example, the control unit 40 of the robot arm 1 determines whether or not the pair of claw portions 11b has gripped the target object based on the electrical signals output from the circuits CB of the main body portion 11. At this time, the control unit 40 measures the force applied to the claw portions 11b based on the electrical signals output from the circuits CB of the detection portions 11b2. For example, the control unit 40 calculates the magnitude of the force applied to the claw portions 11b based on the electrical signals. To be more specific, the control unit 40 measures the magnitude of the force received by the claw portions 11b of the end effector 10 by measuring a voltage change between the input electrode E1 and the output electrode E2 based on such an electrical signal. The measurement processing of the magnitude of a force executed by the control unit 40 of the robot arm 1 will be described.

First, the control unit 40 acquires actual measurement data in a calibration work before actually gripping a target object using the end effector 10 of the robot arm 1, and stores the actual measurement data in the storage unit 20. In the present disclosure, the “actual measurement data” includes, for example, data in which a voltage value of an electrical signal output from the detection portion 11b2 and a magnitude of a force received by the gripping portion 11b1 of the claw portion 11b are associated with each other. The control unit 40 calculates an approximate expression or the like indicating the relationship between the voltage value and the magnitude of the force received by the gripping portion 11b1 based on such actual measurement data, and stores the approximate expression or the like in the storage unit 20.

When determining whether or not the pair of claw portions 11b has gripped the target object by measuring the magnitude of the force received by the claw portions 11b, the control unit 40 calculates the magnitude of the force corresponding to the voltage values of the electrical signals output from the detection portions 11b2 with reference to the above approximate expression or the like based on the past actual measurement data stored in advance in the storage unit 20. The control unit 40 calculates the magnitude of the force received by the gripping portions 11b1 based on the past actual measurement data acquired in advance by the calibration work. When the pair of claw portions 11b grips the target object, a force is applied to the gripping portions 11b1 due to the counteraction thereof, and thus the control unit 40 determines that the pair of claw portions 11b grips the target object, for example, when the magnitude of the calculated force exceeds a predetermined threshold value.

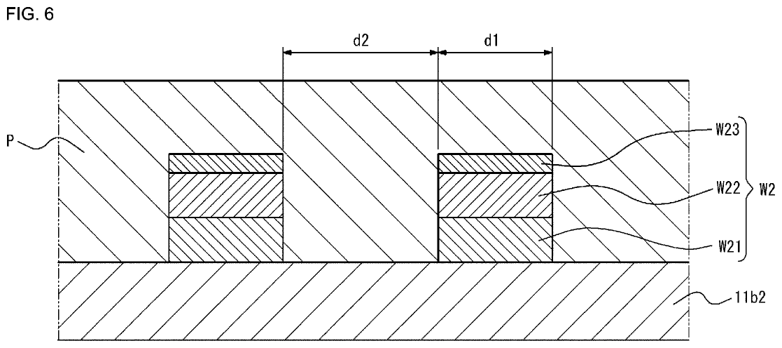

FIG. 6 is an enlarged cross-sectional view schematically illustrating a part of a cross section taken along an arrow line VI-VI in FIG. 5 in an enlarged manner.

In the detection portion 11b2 located in each of the claw portions 11b of the end effector 10, the modulus of elasticity of the resin contained in the detection portion 11b2 is not particularly limited, but is preferably, for example, 1 GPa or more and 50 GPa or less.

In the detection portion 11b2 located in each of the claw portions 11b of the end effector 10, the circuit CB is formed as a plating layer on the surface of the resin contained in the detection portion 11b2 in a manner that the circuit CB is integrated with the resin. In FIG. 6, the gauge line W2 of the wiring W is illustrated as a part of the circuit CB. The configuration of the gauge line W2 described below with reference to FIG. 6 applies similarly to the other components of the circuit CB, such as the input electrode E1, the output electrode E2, and the connection line W1.

The plating layer includes a first layer W21, a second layer W22, and a third layer W23 in this order from the side of the resin contained in the detection portion 11b2. The first layer W21 is formed integrally with the resin contained in the detection portion 11b2. The first layer W21 contains a first metal. For example, in a case where the resin contained in the detection portion 11b2 is configured by blending a metal oxide as a filler, the first metal includes that corresponding to the metal oxide. The first metal includes, for example, copper.

The second layer W22 is formed directly on the first layer W21. The second layer W22 contains a second metal that reduces rust of the first metal contained in the first layer W21. The second metal includes, for example, nickel. The third layer W23 is formed directly on the second layer W22. The third layer W23 contains a third metal having the smallest electrical resistance in the plating layer. The third metal includes, for example, gold.

The total thickness of the plating layer is not particularly limited, but is preferably, for example, 1 μm or more and 30 μm or less. The thickness of the first layer W21 is not particularly limited, but is preferably 2 μm, for example. The thickness of the second layer W22 is not particularly limited, but is preferably 2 μm, for example. The thickness of the third layer W23 is not particularly limited, but is preferably 0.03 μm, for example.

In the detection portion 11b2 located in each of the claw portions 11b of the end effector 10, a protective layer P is further formed immediately on the circuit CB. The protective layer P covers the circuit CB. For example, the protective layer P is formed directly on the circuit CB at a position where the circuit CB is formed, and is formed directly on the resin contained in the detection portion 11b2 while filling gaps of the circuit CB at positions where the circuit CB is not formed.

The protective layer P contains a resin. In the present disclosure, the resin contained in the protective layer P includes, for example, a thermosetting resin. Examples of the “thermosetting resin” include an acrylic resin and an epoxy resin. The total thickness of the protective layer P, that is, the height from the surface of the detection portion 11b2 is not particularly limited, but is preferably 15 μm, for example.

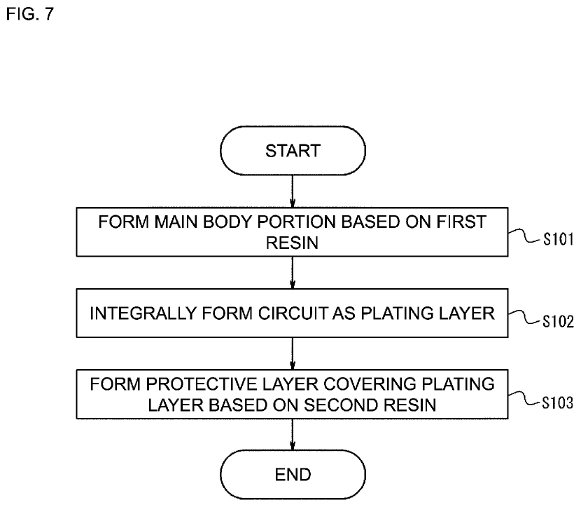

FIG. 7 is a flowchart for explaining an example of a manufacturing method when the end effector 10 in FIG. 1 is manufactured as a measurement device. The flowchart shown in FIG. 7 focuses mainly on steps that are characteristic of the present disclosure among all steps of the method for manufacturing a measurement device, and shows an overview of the method for manufacturing the measurement device.

In step S101, the method for manufacturing the measurement device includes a first step of forming the main body portion 11 of the measurement device with a resin (first resin).

In step S102, the method for manufacturing the measurement device includes a second step of forming, on the first resin, the circuit CB as a plating layer in a manner that the circuit CB is integrated with the first resin. The circuit CB outputs an electrical signal that changes depending on an amount of the strain on the main body portion 11. In the second step, the circuit CB is formed as a plating layer on the surface of the detection portion 11b2 as a molded article by laser irradiation based on LDS. The second step further includes steps of forming the first layer W21 containing the first metal, forming the second layer W22 containing the second metal, and forming the third layer W23 containing the third metal.

In step S103, the method for manufacturing the measurement device includes a third step of forming the protective layer P covering the plating layer with the resin (second resin).

In one or more embodiments, the resin used for the main body portion 11 of the end effector 10 is preferably a thermoplastic resin. The thermoplastic resin is not particularly limited, and examples thereof include polyolefin-based resins such as polypropylene, polyethylene, and polybutene; polyester-based resins such as polyethylene terephthalate and polybutylene terephthalate; polyamide-based resins such as nylon-6 and nylon 6,6 or aromatic polyamide resins; thermoplastic polyimide resins; polyamideimide-based resins; polystyrene-based resins such as polystyrene, syndiotactic polystyrene, acrylonitrile-styrene copolymer resins, and acrylonitrile-butadiene-styrene copolymer resins; polyarylene sulfide-based resins such as polyphenylene sulfide; polyphenylene ether-based resins; polyurethane-based resins; polylactic acid; polyether ether ketone-based resins; polyetherimide-based resins; polyketone-based resins; polyarylate-based resins such as amorphous polyarylate and liquid crystalline polyarylate; and liquid crystalline polyester-based resins.

Among these, as the thermoplastic resin used in one or more embodiments, a thermoplastic polyimide resin, a polyamide-imide-based resin, a polyarylene sulfide-based resin, a polyphenylene ether-based resin, a polyether ether ketone resin, a polyetherimide resin, a polyketone-based resin, a polyarylate-based resin, and a liquid crystalline polyester resin, which are so-called engineering plastics or super engineering plastics excellent in heat resistance, mechanical properties, and the like, are preferable, a polyarylene sulfide-based resin is more preferable from the viewpoint of chemical resistance, heat resistance, and mechanical properties, and a polyphenylene sulfide resin (hereinafter, also referred to as a “PPS resin”) is particularly preferable among polyarylene sulfide-based resins (hereinafter, also referred to as a “PAS resin”).

In one or more embodiments, one of the resins may be used alone or a plurality of the resins may be used in the form of a polymer alloy in which the plurality of the resins are mixed. The resin according to one or more embodiments may contain a filler. The resin containing a filler only needs to contain a filler described below and the resin described above, and may be in the form of a composition containing any additive component described below (a colorant, an antistatic agent, an antioxidant, a heat stabilizer, an ultraviolet stabilizer, an ultraviolet absorber, a foaming agent, a flame retardant, a flame retardant aid, a rust inhibitor, a coupling agent, a silane coupling agent, a thermoplastic elastomer, or a synthetic resin) as necessary.

The polyarylene sulfide resin has a resin structure with a structure in which an aromatic ring and a sulfur atom are bonded to each other as a repeating unit. Specifically, the polyarylene sulfide resin is a resin having a structural site represented by General Formula (1) below as a repeating unit, and further, as necessary, a trifunctional structural site represented by General Formula (2) below as repeating units.

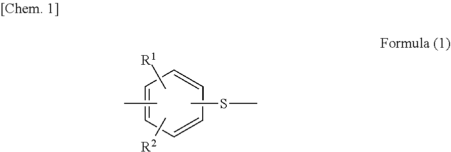

In Formula (1), R¹ and R² each independently represents a hydrogen atom, an alkyl group having 1 to 4 carbon atoms, a nitro group, an amino group, a phenyl group, a methoxy group, or an ethoxy group.

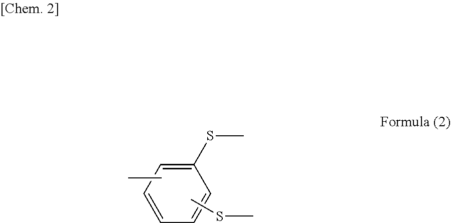

The trifunctional structural site represented by Formula (2) is preferably in a range of 0.001 to 3 mol % and particularly preferably in a range of 0.01 to 1 mol % relative to a total number of moles of the trifunctional structural site and other structural sites.

Here, in the structural site represented by General Formula (1) above, in particular, R¹ and R² in the formula are preferably hydrogen atoms from the viewpoint of mechanical strength of the PAS resin. In that case, examples thereof include those represented by Formula (3) below, in which the sulfur atom is attached at the para position, and those represented by Formula (4) below, in which the sulfur atom is attached at the meta position.

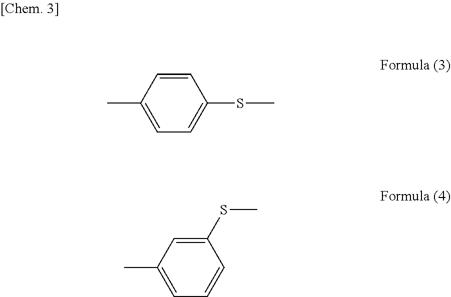

Of these, in particular, the structure represented by General Formula (3) above, in which the sulfur atom is attached at the para position of the aromatic ring in the repeating unit, is preferred in terms of heat resistance and crystallinity of the PAS resin.

The PAS resin may contain not only the structural sites represented by General Formulas (1) and (2) but also structural sites represented by Structural Formulas (5) to (8) below in an amount of 30 mol % or less of a total amount of these structural sites and the structural sites represented by General Formulas (1) and (2).

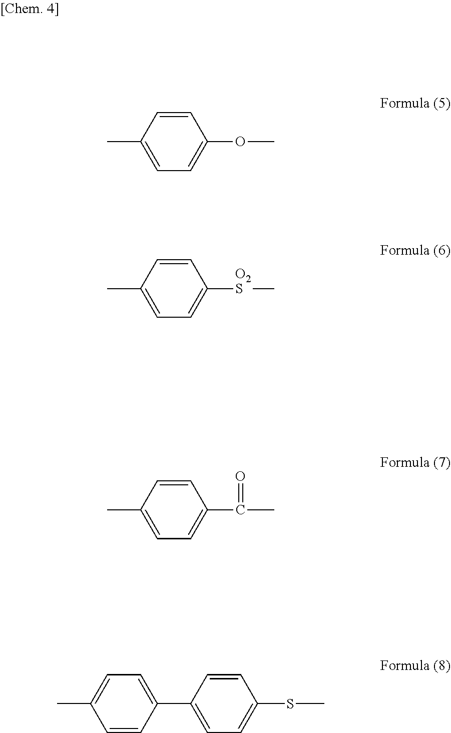

In particular, in one or more embodiments, the structural sites represented by General Formulas (5) to (8) above are preferably in an amount of 10 mol % or less from the viewpoints of heat resistance and mechanical strength of the PAS resin. In the case where the PAS resin contains the structural sites represented by General Formulas (5) to (8) above, their binding modes may be either a random copolymer or a block copolymer.

The PAS resin may have a naphthyl sulfide bond or the like in its molecular structure, and the amount thereof is preferably 3 mol % or less and particularly preferably 1 mol % or less relative to a total number of moles of the bond and other structural sites.

Physical properties of the PAS resin are not particularly limited as long as the effects of one or more embodiments are not impaired, but the physical properties are as follows.

### Melt Viscosity

A melt viscosity of the PAS resin is not particularly limited, but a melt viscosity (V6) as measured at 300° C. is preferably in a range of 2 Pa·s or more, and preferably in a range of 1000 Pa·s or less, more preferably in a range of 500 Pa·s or less, and still more preferably in a range of 200 Pa·s or less because of good balance between fluidity and mechanical strength. However, the melt viscosity (V6) is a measured value of a melt viscosity measured after holding the polyarylene sulfide resin at 300° C., a load of 1.96×10⁶ Pa, and L/D=10 (mm)/1 (mm) for 6 minutes using a flow tester CFT-500D available from Shimadzu Corporation.

### Non-Newtonian Index

A non-Newtonian index of the PAS resin is not particularly limited but is preferably in a range from 0.90 or more to 2.00 or less. In a case where a linear polyarylene sulfide resin is used, the non-Newtonian index is preferably in a range of 0.90 or more and more preferably in a range of 0.95 or more, and is preferably in a range of 1.50 or less and more preferably in a range of 1.20 or less. Such a polyarylene sulfide resin has excellent mechanical physical properties, fluidity, and abrasion resistance. However, in one or more embodiments, the non-Newtonian index (N value) is a value calculated, using the following equation, through measurement of a shear rate (SR) and a shear stress (SS) using a capilograph under conditions of a melting point+20° C. and a ratio of an orifice length (L) to an orifice diameter (D), i.e., L/D=40. A non-Newtonian index (N value) closer to 1 indicates that the structure is closer to a linear structure, and a higher non-Newtonian index (N value) indicates that the structure is more branched.

$$SR = K \cdot {SS}^{N} \qquad [ Equation 1 ]$$

Here, SR represents a shear rate (sec⁻¹). SS represents a shear stress (dyne/cm²). K represents a constant.

In one or more embodiments, the resin used for the main body portion 11 of the end effector 10 is blended with a metal oxide containing at least one of copper or chromium for the purpose of forming a molded circuit using LDS. The metal oxide has a function of generating heat by laser irradiation in the obtained molded article to melt the resin and roughen the surface of the molded article, a function of being activated by laser irradiation to selectively form a plating layer, and the like. When the first metal contained in the first layer W21 is at least one of copper or chromium similarly to the above metal oxide, the adhesion at the interface between the first layer W21 and the resin is improved.

The metal oxide contains at least one of copper or chromium. The metal oxide may further contain another metal such as iron, aluminum, gallium, boron, molybdenum, tungsten, and selenium.

Specific examples of the metal oxide include, but are not particularly limited to, CuFe_{0.5}B_{0.5}O_{2.5}, CuAl_{0.5}B_{0.5}O_{2.5}, CuGa_{0.5}B_{0.5}O_{2.5}, CuB₂O₄, CuB_{0.7}O₂, CuMo_{0.7}O₃, CuMo_{0.5}O_{2.5}, CuMoO₄, CuWO₄, CuSeO₄, and CuCr₂O₄. Among these, the metal oxide is preferably CuCr₂O₄, CuFe_{0.5}B_{0.5}O_{2.5}, or CuAl_{0.5}B_{0.5}O_{2.5}, and more preferably CuCr₂O₄ or CuFe_{0.5}B_{0.5}O_{2.5}. One of these metal oxides may be used alone, or two or more thereof may be used in combination.

The average particle size of the metal oxide is preferably in a range of 0.01 μm or more, and more preferably 0.05 μm or more, and is preferably 50 μm or less, and more preferably 30 μm or less. When the average particle size of the metal oxide is 0.01 μm or more, efficient and stable production can be achieved, which is preferable. On the other hand, when the average particle size of the metal oxide is 50 μm or less, the material strength can be maintained, which is preferable. In the present disclosure, the “average particle size of the metal oxide” means a number average particle size, and a value measured by an electron microscope photography method is adopted. Specifically, the particle sizes of 100 metal oxide particles arbitrarily selected in one field of view of an electron microscope are measured, and the average value thereof is calculated.

The Mohs hardness of the metal oxide is in a range of preferably 4.0 or more to preferably 6.5 or less, and more preferably 6.0 or less.

The blending amount of the metal oxide is in a range from preferably 15 parts by mass or more, more preferably 20 parts by mass or more, and still more preferably 25 parts by mass or more to preferably 90 parts by mass or less, relative to 100 parts by mass of the PAS resin. When the blending amount of the metal oxide relative to 100 parts by mass of the PAS resin is 15 parts by mass or more, it is preferable from the viewpoint that surface roughening by laser irradiation and activation of the metal oxide can occur to a high degree in the obtained molded article, plating properties are excellent, and the like. On the other hand, when the blending amount of the metal oxide relative to 100 parts by mass of the PAS resin is 90 parts by mass or less, the material strength can be maintained, which is preferable.

As other fillers, known and commonly used materials can also be used as long as the effects of one or more embodiments are not impaired, and examples thereof include fillers having various shapes such as a fibrous shape, and non-fibrous shapes such as a granular shape and a plate shape. Specifically, fibrous fillers such as a glass fiber, a carbon fiber, a silane glass fiber, a ceramic fiber, an aramid fiber, a metal fiber, a fiber of potassium titanate, silicon carbide, calcium silicate, or wollastonite, and a natural fiber can be used, and non-fibrous fillers such as a glass bead, a glass flake, barium sulfate, clay, pyrophyllite, bentonite, sericite, mica, talc, kerolite, pimelite, pyrophyllite, hydrotalcite, kaolinite, attapulgite, ferrite, calcium silicate, calcium carbonate, a glass bead, zeolite, a milled fiber, and calcium sulfate can also be used.

In one or more embodiments, the content of the filler is not particularly limited as long as the effects of one or more embodiments are not impaired. The blending amount of the filler is, for example, in a range from preferably 1 part by mass or more, more preferably 10 parts by mass or more to preferably 600 parts by mass or less, more preferably 200 parts by mass or less, relative to 100 parts by mass of the resin. In such a range, the resin exhibits good mechanical strength and moldability, which is preferable.

In one or more embodiments, the resin used for the main body portion 11 of the end effector 10 can be blended with a silane coupling agent as an optional component, as necessary. The silane coupling agent is not particularly limited as long as the effects of one or more embodiments are not impaired, but preferred examples thereof include a silane coupling agent having a functional group reactive with a carboxy group, such as an epoxy group, an isocyanato group, an amino group, or a hydroxy group. Examples of such a silane coupling agent include epoxy group-containing alkoxysilane compounds, such as γ-glycidoxypropyltrimethoxysilane, γ-glycidoxypropyltriethoxysilane, and β-(3,4-epoxycyclohexyl)ethyltrimethoxysilane; isocyanato group-containing alkoxysilane compounds, such as γ-isocyanatopropyltrimethoxysilane, γ-isocyanatopropyltriethoxysilane, γ-isocyanatopropylmethyldimethoxysilane, γ-isocyanatopropylmethyldiethoxysilane, γ-isocyanatopropylethyldimethoxysilane, γ-isocyanatopropylethyldiethoxysilane, and γ-isocyanatopropyltrichlorosilane; amino group-containing alkoxysilane compounds, such as γ-(2-aminoethyl)aminopropylmethyldimethoxysilane, γ-(2-aminoethyl)aminopropyltrimethoxysilane, and γ-aminopropyltrimethoxysilane; and hydroxy group-containing alkoxysilane compounds, such as γ-hydroxypropyltrimethoxysilane and γ-hydroxypropyltriethoxysilane. In one or more embodiments, the silane coupling agent is not an essential component, but in the case of blending, its blending amount is not particularly limited as long as the effects of one or more embodiments are not impaired, but the amount is in a range from preferably 0.01 parts by mass or more and more preferably 0.1 parts by mass or more to preferably 10 parts by mass or less and more preferably 5 parts by mass or less, relative to 100 parts by mass of the resin. The resin blended with the silane coupling agent in such a range has good corona resistance and moldability, in particular, good mold releasability, and a molded article thereof has improved mechanical strength while exhibiting good adhesion with an epoxy resin, which is preferred.

In one or more embodiments, the resin used for the main body portion 11 of the end effector 10 can contain a thermoplastic elastomer as an optional component, as necessary. Examples of the thermoplastic elastomer include a polyolefin-based elastomer, a fluorine-based elastomer, or a silicone-based elastomer. Among these, preferred examples include a polyolefin-based elastomer. In the case of adding an elastomer of these, its blending amount is not particularly limited as long as the effects of one or more embodiments are not impaired but is in a range from preferably 0.01 parts by mass or more and more preferably 0.1 parts by mass or more to preferably 10 parts by mass or less and more preferably 5 parts by mass or less, relative to 100 parts by mass of the resin (A). Blending the thermoplastic elastomer in such a range improves impact resistance of the resulting resin, which is preferred.

Examples of the polyolefin-based elastomer include a homopolymer of an α-olefin, a copolymer of two or more α-olefins, and a copolymer of one or two or more α-olefins and a vinyl polymerizable compound having a functional group. At this time, examples of the α-olefin include α-olefins with carbon atoms in a range from 2 or more to 8 or less, such as ethylene, propylene, and 1-butene. Examples of the functional group include a carboxy group, an acid anhydride group (—C(═O) OC(═O)—), an epoxy group, an amino group, a hydroxy group, a mercapto group, an isocyanate group, and an oxazoline group. Examples of the vinyl polymerizable compound having the functional group include one or two or more of vinyl acetate; α,β-unsaturated carboxylic acids, such as (meth)acrylic acid; alkyl esters of α,β-unsaturated carboxylic acids, such as methyl acrylate, ethyl acrylate, and butyl acrylate; metal salts of α,β-unsaturated carboxylic acids, such as ionomers (examples of the metal include alkali metals, such as sodium; alkaline earth metals, such as calcium; and zinc); glycidyl esters of α,β-unsaturated carboxylic acids, such as glycidyl methacrylate; α,β-unsaturated dicarboxylic acids, such as maleic acid, fumaric acid, and itaconic acid; and derivatives (monoesters, diesters, and acid anhydrides) of the α,β-unsaturated dicarboxylic acids. One of the thermoplastic elastomers described above may be used individually, or two or more may be used in combination.

In one or more embodiments, the resin used for the main body portion 11 of the end effector 10 may further contain, in addition to the above-described components, synthetic resins such as polyester resins, polyamide resins, polyimide resins, polyetherimide resins, polycarbonate resins, polyphenylene ether resins, polysulfone resins, polyethersulfone e resins, polyetheretherketone resins, polyetherketone resins, polyarylene resins, polyethylene resins, polypropylene resins, polytetrafluoroethylene resins, polydifluoroethylene resins, polystyrene resins, ABS resins, phenol resins, urethane resins and liquid crystal polymers (hereinafter simply referred to as a synthetic resin) as optional components, as appropriate, depending on the application. In one or more embodiments, the synthetic resin is not an essential component, but in the case of blending, a proportion of the blending is not particularly limited as long as the effects of one or more embodiments are not impaired. In addition, the proportion varies according to each purpose and cannot be unconditionally specified, but the proportion of the synthetic resin to be blended in the resin according to one or more embodiments is, for example, in a range of 5 parts by mass or more and approximately in a range of 15 parts by mass or less, relative to 100 parts by mass of the resin. In other words, the proportion of the resin (A) to the total of the resin (A) and the synthetic resin is preferably in a range of (100/115) or more and more preferably in a range of (100/105) or more on a mass basis.

In one or more embodiments, the resin used for the main body portion 11 of the end effector 10 may contain a known and commonly used additive as an optional component, as necessary, such as a colorant, an antistatic agent, an antioxidant, a heat-resistant stabilizer, an ultraviolet stabilizer, an ultraviolet absorber, a foaming agent, a flame retardant, a flame retardant aid, a rust inhibitor, and a coupling agent. An additive of these is not an essential component and only needs to be used by appropriately adjusting the amount according to the purpose and/or application so as not to impair the effects of one or more embodiments, for example, preferably in a range of 0.01 parts by mass or more and in a range of preferably 1000 parts by mass or less, relative to 100 parts by mass of the resin.

A method for manufacturing the resin used for the main body portion 11 of the end effector 10 in one or more embodiments will be described in detail below.

In one or more embodiments, the resin used for the main body portion 11 of the end effector 10 is obtained by blending essential components and other optional components as necessary. In one or more embodiments, the method for manufacturing the resin used for the main body portion 11 of the end effector 10 is not particularly limited, but examples include a method of blending the essential components and an optional component as necessary, and melt-kneading the components, more specifically, a method of uniformly dry-mixing the components with a tumbler, a Henschel mixer, or the like as necessary, and then feeding the mixture into a twin-screw extruder to melt-knead the mixture.

The melt-kneading can be performed by heating the mixture to a temperature range where the resin temperature is a melting point of the resin or higher, preferably a temperature range of the melting point+10° C. or higher, and more preferably a temperature range from the melting point+10° C. or higher and still more preferably the melting point+20° C. or higher to preferably the melting point+100° C. or lower and more preferably the melting point+50° C. or lower.

The melt-kneading machine is preferably a twin-screw kneading extruder from the viewpoints of dispersibility and productivity. For example, the mixture is preferably melt-kneaded while a discharge amount of the resin component in a range of 5 to 500 (kg/hr) and a screw rotation speed in a range of 50 to 500 (rpm) are appropriately adjusted, and the mixture is more preferably melt-kneaded under the condition that a ratio (discharge amount/screw rotation speed) is in a range of 0.02 to 5 (kg/hr/rpm). The addition of the components to the melt-kneading machine and the mixing may be performed simultaneously or separately. For example, in the case of adding an additive among the components, the additive is preferably fed from a side feeder of the twin-screw kneading extruder into the extruder from the viewpoint of dispersibility. For the position of such a side feeder, a ratio of a distance from a resin feeding portion (top feeder) of the extruder to the side feeder to a total length of a screw of the twin-screw kneading extruder is preferably 0.1 or more and more preferably 0.3 or more. Such a ratio is preferably 0.9 or less and more preferably 0.7 or less.

The resin according to one or more embodiments obtained by the melt-kneading in this way is a melted mixture containing the essential components, optional components added as necessary, and components derived therefrom, and is preferably preliminarily dried as necessary by a known method, for example, in a temperature range of 100 to 150° C. after extrusion-molding the resin in a molten state into a strand shape and then processing into a form, such as pellets, chips, granules, or powder, after the melt-kneading.

A molded article of one or more embodiments is formed by molding the resin. A method for manufacturing the molded article according to one or more embodiments includes a step of melt-molding the resin. This method will be described in detail below.

In one or more embodiments, the resin used for the main body portion 11 of the end effector 10 is subjected to injection molding. Various molding conditions are not particularly limited, and the resin can be usually molded by a common method. For example, after undergoing a process of melting the resin in an injection molding machine in a temperature range where the resin temperature is a melting point of the resin or higher, preferably in a temperature range of the melting point+10° C. or higher, more preferably in a temperature range of the melting point+10° C. to the melting point+100° C., and still more preferably in a temperature range of the melting point+20 to the melting point+50° C., the resin is injected from a resin discharge port into a mold and molded. At this time, a mold temperature may also be set in a known temperature range of, for example, from room temperature (23° C.) to 300° C., and preferably from 120 to 180° C.

According to the end effector 10 as a measurement device obtained by the manufacturing method according to the embodiments as described above, it is possible to contribute to measurement of a force with a simpler configuration. The end effector 10 is manufactured by the second step of forming, on the surface of the resin, the circuit CB as a plating layer in a manner the circuit CB is integrated with the resin. The circuit CB outputs an electrical signal that changes depending on an amount of the strain on the main body portion 11. And thus, it is not necessary to additionally mount a sensor component such as a strain gauge for measuring a force as in the related art. For example, when a strain gauge type force sensor as described in Patent Document 1 is considered, the force sensor is present as a separate component and needs to be separately attached to a target device. Accordingly, it is necessary to provide an extra space for attaching the force sensor as a separate component in the target device, or this leads to an increase in weight of the target device.

On the other hand, in the end effector 10 according to one or more embodiments, the arrangement of the lead wire corresponding to the strain gauge can also be omitted. The end effector 10 does not require a sheet or a film for a sensor component, a substrate on which an electric circuit is formed, or the like to be separately disposed. The end effector 10 does not need to be provided with a joint portion or a bonding portion of a sheet, a film, a substrate, or the like separately. The end effector 10 can contribute to measurement of a force with the simpler configuration as described above.

The end effector 10 can achieve reduction in the number of components, miniaturization, and weight reduction, and can also satisfy the weight capacity limit of the robot arm 1. The end effector 10 can also improve the degree of freedom of shape design. In addition, the end effector 10 has improved waterproofness and water resistance due to the main body portion 11 containing the resin, and can be cleaned for the purpose of preventing spread of infection and other hygienic aspects. The end effector 10 is light in weight and can suppress rust during cleaning, unlike a metal end effector in the related art.

The end effector 10 is manufactured by the manufacturing method as illustrated in FIG. 7, and thus it is possible to shorten the manufacturing process. Accordingly, the end effector 10 can be delivered as a product in a short delivery time, and the cost required from manufacture to delivery can be reduced. On the other hand, when the strain gauge type force sensor as described in Patent Document 1 is considered, the manufacturing process of the circuit pattern is widely divided into coating, resist application, pre-baking, exposure, development/rinsing, post-baking, etching, and resist removal.

The end effector 10 is manufactured based on the third step of forming the protective layer P covering the plating layer with the second resin, and thus the circuit CB as the plating layer can be protected. For example, the end effector 10 can reduce defects such as contamination, scratches, and damage of the circuit CB by the protective layer P.

The circuit CB has the wiring W formed on the surface of the resin, and outputs an electrical signal that changes depending on the electrical resistance of the wiring W itself. This makes the end effector 10 an integral molded article that measures a force by directly drawing the circuit CB on the end effector 10. In the end effector 10, the drawn circuit CB itself serves as a means for transmitting an electrical signal, and thus it is not necessary to additionally provide wiring such as a harness, a substrate, or the like. The end effector 10 does not require a shape or a space for accommodating a harness as a wire and a substrate on which a circuit is formed, and can avoid complication of the shape, whereby the configuration can be further simplified.

The end effector 10 tends to be charged due to the main body portion 11 containing the resin, but even in such a case, the end effector 10 can be easily neutralized by the wiring W of plating in the circuit CB formed on the surface and made of a metal. The end effector 10 can effectively eliminate the static electricity by the path shape of the wiring W directly drawn on the surface thereof.

In the end effector 10, the width d1 of the line of the wiring W is 10 μm or more and 1 mm or less, and thus an optimal circuit pattern can be formed in accordance with bendability of the detection portion 11b2 which changes depending on the thickness, materials, and the like of the claw portion 11b. For example, in a case where the detection portion 11b2 has a high modulus of elasticity and the claw portion 11b is formed to be hard, the width d1 is preferably narrowed to more easily cause a change in electrical resistance of the wiring W itself even for a minute strain in the detection portion 11b2. On the contrary, in a case where the detection portion 11b2 has a low modulus of elasticity and the claw portion 11b is formed to be soft, there is no problem even when the width d1 is larger to appropriately cause a change in electrical resistance of the wiring W itself for a large strain in the detection portion 11b2. As described above, the end effector 10 can cause the detection portion 11b2 to function as a strain gauge having appropriate sensibility in accordance with the modulus of elasticity of the resin of the claw portion 11b by variably setting the value of the width d1 of the line of the wiring W.

In the end effector 10, the interval d2 between the lines of the wiring W is 10 μm or more and 1 mm or less, and thus an optimal circuit pattern can be formed in accordance with the bendability of the detection portion 11b2 that changes depending on the thickness, materials, and the like of the claw portion 11b. For example, in the case where the detection portion 11b2 has a high modulus of elasticity and the claw portion 11b is formed to be hard, the interval d2 is preferably narrowed to more easily cause a change in electrical resistance of the wiring W itself even for a minute strain in the detection portion 11b2. On the contrary, in a case where the detection portion 11b2 has a low modulus of elasticity and the claw portion 11b is formed to be soft, there is no problem even when the interval d2 is larger to appropriately cause a change in electrical resistance of the wiring W itself for a large strain in the detection portion 11b2. As described above, the end effector 10 can cause the detection portion 11b2 to function as a strain gauge having appropriate sensibility in accordance with the modulus of elasticity of the resin of the claw portion 11b by variably setting the value of the interval d2 of the lines of the wiring W.

In the end effector 10, when each of the width d1 and the interval d2 is narrowed to about 50 μm, even for a minute strain on the detection portion 11b2, the electrical resistance of the wiring W itself can be more easily changed. Thus, the end effector 10 can contribute to the measurement of a force even in a case where the magnitude of the force is very small or the modulus of elasticity of the resin of the detection portion 11b2 is high. The end effector 10 can cause the detection portion 11b2 to function as a strain gauge with higher sensitivity.

When the plating layer includes the first layer W21 that is formed integrally with the first resin and contains the first metal, for example, the adhesion at the interface between the first resin that is formed by blending a metal oxide containing a metal similar to the first metal and the first layer W21 is improved. Accordingly, the end effector 10 can stably form the plating layer on the surface of the resin of the detection portion 11b2. In the end effector 10, the second layer W22 containing the second metal is formed directly on the first layer W21, and thus rust of the first metal can be reduced. In the end effector 10, the third layer W23 containing the third metal having the smallest electrical resistance is formed directly on the second layer W22, and thus the electrical resistance received by the electrical signal transmitted through the circuit CB can be reduced.

When the thickness of the plating layer is 1 μm or more and 30 μm or less, the electrical resistance of the wiring W itself can be more easily changed even for a minute strain in the detection portion 11b2. Thus, the end effector 10 can contribute to the measurement of a force even in a case where the magnitude of the force is very small or the modulus of elasticity of the resin of the detection portion 11b2 is high. The end effector 10 can cause the detection portion 11b2 to function as a strain gauge with higher sensitivity.

The circuit CB includes the strain gauge, and thus the end effector 10 can output a voltage signal corresponding to the force applied to the gripping portion 11b1 to the control unit 40. This allows the end effector 10 to contribute to the measurement processing of the magnitude of the force by the control unit 40. The control unit 40 can accurately calculate the magnitude of the force applied to the gripping portion 11b1 based on the voltage signal obtained from the end effector 10.

When the resin contains a thermoplastic resin and the thermoplastic resin is a polyarylene sulfide resin, the end effector 10 can improve waterproofness and water resistance. In addition, the end effector 10 can also improve chemical resistance and heat resistance due to the excellent chemical resistance and heat resistance of the polyarylene sulfide resin. This allows the end effector 10 to be used in chemicals, hot substances, and the like. For example, the end effector 10 can also grip a target object that requires chemical resistance.

The resin is configured by blending the metal oxide containing at least one of copper or chromium, and thus the end effector 10 facilitates the formation of a molded circuit using LDS. The end effector 10 can provide a function of generating heat by laser irradiation to melt the resin and roughen the surface thereof, a function of being activated by laser irradiation and enabling a plating layer to be selectively formed, and the like, by a metal oxide containing at least one of copper or chromium.

In the end effector 10, the modulus of elasticity of the first resin is 1 GPa or more and 50 GPa or less, and thus, the bendability of the claw portion 11b including the detection portion 11b2 can be variably set within the numerical range. Accordingly, the end effector 10 can achieve the optimum bendability for the claw portion 11b in accordance with the circuit pattern of the strain gauge in the detection portion 11b2. In the end effector 10, the modulus of elasticity of the first resin of the claw portion 11b can be optimized so that the detection portion 11b2 contributes to the measurement of a force.

The control unit 40 of the robot arm 1 determines whether or not the target object is gripped based on the electrical signal output from the circuit CB of the main body portion 11, thereby enabling the robot arm 1 to perform a moving operation and the like of the target object. The robot arm 1 can also move the gripped target object from one place to another place in a state of recognizing that the target object is gripped.

The detection portion 11b2 is thinner than the gripping portion 11b1 in each of the claw portions 11b, for example, as illustrated in FIG. 3. Thus, in the end effector 10, the thickness of the gripping portion 11b1 that comes into contact with the target object can be relatively increased to form the gripping portion 11b1 to be robust, while the detection portion 11b2 including the strain gauge portion in the circuit CB can be narrowed to be easily strained. Accordingly, the end effector 10 can contribute to the measurement of a force even in the case where the magnitude of the force is very small or the modulus of elasticity of the resin of the detection portion 11b2 is high. The end effector 10 can cause the detection portion 11b2 to function as a strain gauge with higher sensitivity.

For example, the end effector 10 can more easily cause a change in electrical resistance of the wiring W itself due to the strain on the detection portion 11b2 by the wiring W of the circuit CB having a pattern as illustrated in FIG. 5. Accordingly, the end effector 10 can contribute to the measurement of a force even in the case where the magnitude of the force is very small or the modulus of elasticity of the resin of the detection portion 11b2 is high. The end effector 10 can cause the detection portion 11b2 to function as a strain gauge with higher sensitivity.

It will be apparent to those skilled in the art that the present disclosure may be embodied in other specific forms than the embodiments described above without departing from the spirit or essential characteristics thereof. Accordingly, the foregoing description is by way of example only and is not intended as limiting. The scope of the disclosure is defined by the appended claims, rather than by the foregoing description. Any and all modifications that fall within the meaning and range of equivalency of the claims are intended to be encompassed therein.

For example, the shape, pattern, size, arrangement, orientation, type, number, and the like of each of the above-described components are not limited to the contents described above and illustrated in the drawings. The shape, pattern, size, arrangement, orientation, type, number, and the like of each component may be arbitrarily configured as long as the function thereof can be realized. The components of the end effector 10 and the robot arm 1 illustrated in the drawings are functionally conceptual, and the specific forms of the components are not limited to those illustrated in the drawings.

For example, the functions included in the steps of the manufacturing method may be rearranged not to be logically inconsistent, and a plurality of steps may be combined into one or a step may be divided.

In the above embodiments, the measurement device has been described as including the end effector 10, but the measurement device is not limited thereto. The measurement device may include any other device. For example, the measurement device may include another device used for a joint portion of the robot arm 1, another arbitrary portion of a robot having the robot arm 1, or the like, or may include a device such as an actuator. The measurement device is not limited to a device for a robot such as the end effector 10 used in the robot arm 1, and may include a device used for a precision machine, a device attached to the distal tip of a viscometer in a stirring device, or the like. The measurement device may cover all devices in which a sensor such as a strain gauge needs to be integrally formed.

In the above embodiments, it has been described that the method for manufacturing the measurement device includes the third step of forming the protective layer P covering the plating layer with the second resin, but the method for manufacturing the measurement device is not limited thereto. The method for manufacturing the measurement device need not include such a third step. At this time, in the end effector 10, the protective layer P need not be formed directly on the circuit CB. The circuit CB may be exposed without being covered with the protective layer P.

In the above embodiments, it has been described that the circuit CB has the wiring W formed on the surface of the resin and outputs the electrical signal that changes depending on the electrical resistance of the wiring W itself, but the circuit CB is not limited thereto. The circuit CB may include a substrate integrally molded with the resin of the main body portion 11 and wiring formed on the substrate, and may output an electrical signal that changes depending on the electrical resistance of the wiring itself.

The circuit CB may be configured based on a substrate integrally molded with a resin by, for example, insert molding. In the circuit CB, the wiring and the electrode may be formed on the substrate. The circuit CB may be configured as a molded circuit using IME of the MID, for example. “IME” is an abbreviation for In-Mold Electronics. The circuit CB may be formed by inserting a flexible substrate or the like at the time of injection molding. This makes the end effector 10 an integrally molded article that contributes to the measurement of a force by integrally molding the substrate with the resin.

In the above embodiments, it has been described that the circuit CB contributes to the measurement of a force based on the wiring W itself, but the circuit CB is not limited thereto. The circuit CB may include a sensor component that is mounted on the circuit CB by soldering or the like and contributes to the measurement of a force, instead of or in addition to the wiring W that contributes to the measurement of the force.

In addition, the circuit CB may have a control element that is mounted on the circuit CB by soldering or the like and executes processing necessary for realizing the measurement of a force. In the present disclosure, the “control element” may include, for example, a microcontroller, a processor, a programmable circuit, a dedicated circuit, or any combination thereof. Thus, the end effector 10 can execute the various types of processing described above performed by the control unit 40 of the robot arm 1 by the end effector 10 itself. The end effector 10 can also execute the determination process, the learning process, and other arbitrary processes by itself.

In the above embodiments, it has been described that the width d1 of the line of the wiring W is 10 μm or more and 1 mm or less, but the width d1 is not limited thereto. The width d1 of the line of the wiring W need not be included in such a numerical range.

In the above embodiments, it has been described that the interval d2 between the lines of the wiring W is 10 μm or more and 1 mm or less, but the interval d2 is not limited thereto. The interval d2 between the lines of the wiring W need not be included in such a numerical range.

In the above embodiments, it has been described that the plating layer includes the first layer W21, the second layer W22, and the third layer W23 in this order, but the plating layer is not limited thereto. The plating layer is not limited to a three-layer structure, and only needs to include at least one layer. Although it has been described that the plating layer contains copper, nickel, and gold as the first metal, the second metal, and the third metal, respectively, the plating layer is not limited thereto. The plating layer may contain a nickel alloy. In the present disclosure, the “nickel alloy” includes a nickel-copper alloy, a nickel-gold alloy, a nickel-chromium alloy, and the like. This improves the properties of the plating layer, such as corrosion resistance, thermal conductivity, and oxidation resistance.

In the above embodiments, it has been described that the thickness of the plating layer is 1 μm or more and 30 μm or less, but the thickness of the plating layer is not limited thereto. The thickness of the plating layer need not be included in such a numerical range.

In the above embodiments, it has been described that the circuit CB includes the strain gauge, but the circuit CB is not limited thereto. The circuit CB may include any other component that allows the end effector 10 to contribute to the measurement of a force.

In the above embodiments, it has been described that the modulus of elasticity of the first resin is 1 GPa or more and 50 GPa or less, but the modulus of elasticity of the first resin is not limited thereto. The modulus of elasticity of the first resin need not be included in such a numerical range.

In the above embodiments, it has been described that the first resin is configured by blending a metal oxide containing at least one of copper or chromium, but the first resin is not limited thereto. The first resin need not be configured by blending such a metal oxide. Even when the metal oxide is not blended in the first resin, the formation of the plating layer by LDS is possible by the anchor effect. A catalyst of plating flows into a hole portion formed by melting the resin by laser irradiation and roughening the surface of the molded article, whereby the plating is physically integrated with the first resin.

In the above embodiments, it has been described that the control unit 40 of the robot arm 1 determines whether or not a target object is gripped based on the electrical signal output from the circuit CB of the main body portion 11, but the control unit 40 is not limited thereto. The control unit 40 need not execute such a determination process.

In the above embodiments, it has been described that the end effector 10 contributes to the measurement of a force, and the control unit 40 of the robot arm 1 calculates the magnitude of the force applied to the claw portion 11b based on the electrical signal, but the end effector 10 is not limited thereto. The end effector 10 may contribute to the measurement of the direction of a force as well as the magnitude of the force by appropriately arranging a plurality of strain gauges, for example. The end effector 10 may also contribute to measurement in, for example, six axis directions, that is, three axis directions of an X axis, a Y axis, and a Z axis, and rotational directions about the respective axes. The end effector 10 may integrally include a force sensor as a sensor formed on the detection portion 11b2.

In the above embodiments, it has been described that the detection portion 11b2 is thinner than the gripping portion 11b1, but the detection portion 11b2 is not limited thereto. The detection portion 11b2 may be as wide as the gripping portion 11b1 or thicker than the gripping portion 11b1, as long as the end effector 10 can contribute to the measurement of a force.

In the above embodiments, it has been described that the entire main body portion 11 is formed of a resin, but the main body portion 11 is not limited thereto. It is sufficient that at least a portion of the main body portion 11 where the circuit CB is formed is formed of a resin, and the other portion of the main body portion 11 may be formed of any material other than the resin.

In the above embodiments, it has been described that the end effector 10 has only one pair of claw portions 11b in the main body portion 11, but the end effector 10 is not limited thereto. The end effector 10 may have three or more claw portions 11b or may have only one claw portion 11b.

In the above embodiments, it has been described that the control unit 40 of the robot arm 1 measures the magnitude of a force based on the past actual measurement data acquired in advance by the calibration work, but the control unit 40 is not limited thereto. The control unit 40 may calculate the magnitude of a force without using such past actual measurement data. For example, as long as the control unit 40 can refer to, as information, a theoretical formula for calculating the magnitude of a force, which includes, as a parameter, the voltage value of an electrical signal output from the circuit CB of the detection portion 11b2, the control unit 40 may calculate the magnitude of the force based on the theoretical formula.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Robot arm
1a Housing
10 End effector (measurement device)
11 Main body portion
11a Attachment portion
11b Claw portion
11b1 Gripping portion
11b2 Detection portion
20 Storage unit
30 Drive unit
40 Control unit
CB Circuit
D1 Separation direction
E1 Input electrode
E2 Output electrode
P Protective layer
W Wiring
W1 Connection line
W2 Gauge line
d1 Width
d2 Interval

What is claimed is:

1. A method for manufacturing a measurement device integrally having a sensor that measures a force, the method comprising:
forming, with a first resin, a main body portion of the measurement device; and
forming, on a surface of the first resin, a circuit as a plating layer to be integrated with the first resin, wherein
the circuit is configured to output an electrical signal that changes depending on an amount of strain on the main body portion.

2. The method according to claim 1, further comprising:
forming, with a second resin, a protective layer covering the plating layer.

3. The method according to claim 1, wherein
the forming of the circuit comprises forming wiring on the surface of the first resin, and
the circuit is configured to output the electrical signal that changes depending on an electrical resistance of the wiring.

4. The method according to claim 3, wherein a width of a line of the wiring is 10 μm or more and 1 mm or less.

5. The method according to claim 3, wherein an interval between lines of the wiring is 10 μm or more and 1 mm or less.

6. The method according to claim 1, further comprising integrating the plating layer with the first resin, wherein the integrated plaint layer comprises a first layer containing a first metal, a second layer containing a second metal that reduces rust of the first metal, and a third layer containing a third metal having a smallest electrical resistance in this order.

7. The method according to claim 1, wherein the plating layer contains a nickel alloy.

8. The method according to claim 1, wherein the plating layer has a thickness of 1 μm or more and 30 μm or less.

9. The method according to claim 1, wherein the circuit comprises a strain gauge.

10. The method according to claim 1, wherein the first resin includes a thermoplastic resin.

11. The method according to claim 10, wherein the thermoplastic resin includes at least one selected from a group consisting of a general-purpose plastic, an engineering plastic, and a super engineering plastic.

12. The method according to claim 11, wherein the thermoplastic resin is a polyarylene sulfide resin.

13. The method according to claim 1, wherein the first resin has a modulus of elasticity of 1 GPa or more and 50 GPa or less.

14. The method according to claim 1, wherein the first resin is a blend of a metal oxide containing at least one of copper or chromium.

15. A robot arm comprising, as an end effector, a measurement device manufactured by the method according to claim 1.

16. The robot arm according to claim 15, further comprising:
a controller that determines whether a target object is gripped, based on the electrical signal output from the circuit of the main body portion.

17. The robot arm according to claim 15, wherein
the main body portion of the measurement device comprises:
a gripping portion configured to grip a target object; and
a detection portion configured to be strained depending on a force applied to the gripping portion, the detection portion including the circuit, and
the detection portion is thinner than the gripping portion.
